(19) United States
(12) Patent Application Publication
(10) Pub. No.: US 2004/0035825 A1
(43) Pub. Date: Feb. 26, 2004

(54) Dry etching gas and method for dry etching

(76) Inventors: Shingo Nakamura, Settsu-shi (JP); Mitsushi Itano, Settsu-shi (JP)

Correspondence Address: ARMSTRONG, KRATZ, QUINTOS, HANSON & BROOKS, LLP, 1725 K STREET, NW, SUITE 1000, WASHINGTON, DC, 20006, US

(21) Appl. No.: 10/415,647

(22) PCT Filed: Nov. 8, 2001
(86) PCT No.: PCT/JP01/09769

(30) Foreign Application Priority Data
Nov. 8, 2000 (JP) 2000-341110

(51) Int. Cl. C23F 1/00; C09K 13/00

(52) U.S. Cl. 216/67; 252/79.1

(57) ABSTRACT

A dry etching gas containing a compound having a CF₃C fragment directly bonded to a triple bond.

### TECHNICAL FIELD

The present invention relates to a dry etching gas and a dry etching method.

### BACKGROUND OF THE INVENTION

With the integration of semiconductor devices, the formation of fine patterns such as contact holes, via holes, wiring patterns, and the like with a high aspect ratio (depth/(pattern size such as hole diameter)) has become a necessity. Heretofore, patterns such as contact holes have frequently been etched by introducing a gas such as c-C₄F₈/Ar(/O₂) or the like containing a large amount of Ar into an etching reactor and generating a plasma. However, cyclic c-C₄F₈ contributes significantly to global warming, and a reduction of the emissions thereof will be mandatory in the future. Thus, its use is likely to be limited. Further, when an excellent etching shape is desired in, for example, oxidized film etching, cyclic c-C₄F₈ that is not combined with Ar is insufficient in resist selectivity and silicon selectivity. Moreover, unless oxygen is added, ions have difficulty reaching the deep portions of patterns as pattern size becomes increasingly smaller, and the fluorocarbon polymer films are thus likely to be deposited. As a result, the etching rate decreases (called the microloading effect), and etching stops under fine pattern conditions (called etch-stopping). Even when the microloading effect is prevented by the addition of oxygen, it is difficult to form patterns with a high aspect ratio since the resist selectivity and silicon selectivity to the materials to be etched are decreased. Further, it has been reported that the use of a large amount of Ar causes the number of high-energy electrons to increase in the plasma, resulting in device damage (T. Mukai and S. Samukawa, Proc. Symp. Dry. Process. Tokyo (1999) pp. 39 to 44).

An object of the present invention is to provide a dry etching gas and a dry etching method that prevent any reduction in the etching rate even when etching small holes such as contact holes, via holes and the like, or lines, spaces, wiring patterns and the like; have little pattern-size dependency; and are able to form fine, high-aspect-ratio patterns with no etch stopping through the use of an etching gas that has a substantially small effect on global warming.

### DISCLOSURE OF THE INVENTION

The present invention provides the following dry etching gases and dry etching methods.

Item 1. A dry etching gas comprising a compound that has a fluorocarbon skeleton and a triple bond and may contain a heteroatom.

Item 2. The dry etching gas according to Item 1 comprising at least one triple-bond-containing compound represented by General Formula (1):

General Formula (1):

CₐF_{b}X_{c} (1)

wherein X is Cl, Br, I or H; a is 2 to 7; b is 1 to 12; c is 0 to 8: and b+c is 2a−2.

Item 3. The dry etching gas according to Item 1 comprising at least one compound represented by General Formula (2):

CₘF₂ₘ₊₁C═CY (2)

wherein m is 1 to 5, Y is F, I, H or C_{d}FₑH_{f} (d is 1 to 4, e is 0 to 9, f is 0 to 9, e+f is 2d+1, and m+d is smaller than 6).

Item 4. The dry etching gas according to Item 1 comprising at least one compound represented by General Formula (3):

CF₃C═CY (3)

wherein Y is F, I, H or C_{d}FₑH_{f} (d is 1 to 4, e is 0 to 9, f is 0 to 9, e+f is 2d+1).

Item 5. The dry etching gas according to Item 4 comprising at least one member selected from the group consisting of CF₃C═CCF₃, CF₃C═CF, and CF₃C═CCF₂CF₃.

Item 6. The dry etching gas according to Item 5 comprising CF₃C═CCF₃.

Item 7. The dry etching gas according to any of Items 1 to 5 further comprising at least one member selected from the group consisting of CF₃CF═CFCF₃, CF₂═CF₂, and CF₃CF═CF₂.

Item 8. The dry etching gas according to Item 6 further comprising CF₃CF═CFCF₃.

Item 9. The dry etching gas according to any of Items 1 to 6 further comprising at least one double-bond-containing compound represented by General Formula (4):

C_{g}FₕXᵢ (4)

wherein X is Cl, Br, I or H; g is 2 to 6; h is 4 to 12; i is 0 to 2; and h+i is 2g.

Item 10. The dry etching gas according to any of Items 1 to 6 further comprising at least one compound represented by General Formula (5):

Rfh=CX¹Y¹ (5)

wherein Rfh is one member selected from the group consisting of CF₃CF, CF₃CH, and CF₂; and X¹ and Y¹ are the same or different, and independently represent F, Cl, Br, I, H or CⱼFₖHₗ (j is 1 to 4, and k+l is 2j+1).

Item 11. The dry etching gas according to any of Items 1 to 6 further comprising at least one compound represented by General Formula (6):

R_{f}=C(CₚF₂ₚ₊₁)(C_{q}F_{2q+1}) (6)

wherein Rf is CF₃CF or CF₂; p and q are the same or different, and independently represent 0, 1, 2 or 3; and p+q is smaller than 5.

Item 12. The dry etching gas according to any of Items 1 to 8 further comprising at least one member selected from the group consisting of noble gases, inert gases, NH₃, H₂, hydrocarbons, O₂, oxygen-containing compounds, halogenated compounds, HFC (hydrofluorocarbons), and PFC (perfluorocarbon) gases having at least one single bond or double bond.

Item 13. The dry etching gas according to any of Items 1 to 8 further comprising at least one member of gas selected from the group consisting of noble gases such as He, Ne, Ar, Xe and Kr; inert gases such as N₂; NH₃; H₂; hydrocarbons such as CH₄, C₂H₆, C₃H₈, C₂H₄, C₃H₆ and the like; O₂; oxygen-containing compounds such as CO, CO₂, (CF₃)₂C═O, CF₃CFOCF₂, CF₃OCF₃ and the like; halogenated compounds such as CF₃I, CF₃CF₂I, (CF₃)₂CFI, CF₃CF₂CF₂I, CF₃Br, CF₃CF₂Br, (CF₃)₂CFBr, CF₃CF₂CF₂Br, CF₃Cl, CF₃CF₂Cl, (CF₃)₂CFCl, CF₃CF₂CF₂Cl, CF₂═CFI, CF₂═CFCl, CF₂═CFBr, CF₂=Cl₂, CF₂═CCl₂, CF₂═CBr₂ and the like; HFC (hydrofluorocarbons) such as CH₂F₂, CHF₃, CF₃CHF₂, CHF₂CHF₂, CF₃CH₂F, CHF₂CH₂F, CF₃CH₃, CH₂FCH₂F, CF₂═CHF, CHF═CHF, CH₂═CF₂, CH₂═CHF, CF₃CH═CF₂, CF₃CH═CH₂, CH₃CF═CH₂, and the like; and PFC (perfluorocarbon) gases having at least one single bond or double bond such as CF₄, C₂F₆, C₃F₈, C₄F₁₀, c-C₄F₈, CF₂═CF₂, CF₂═CFCF═CF₂, CF₃CF═CFCF═CF₂, c-C₅F₈, and the like.

Item 14. A dry etching method comprising etching a silicon material such as a silicon oxide film and/or a silicon-containing, low-dielectric-constant film by means of a gas plasma of the dry etching gas defined in any of Items 1 to 13.

The phrase “a compound that has a fluorocarbon skeleton and a triple bond and may contain a heteroatom” herein refers to a compound that has the basic skeleton formed by fluorine and carbon, has a triple bond (—C═C—) structure, and may further contain an atom other than fluorine and carbon. Heteroatoms include Cl, Br, I, etc.

Dry etching gases usable in the present invention contain at least one compound that has the basic skeleton formed by fluorine and carbon, has a triple bond (—C═C—) structure, and may contain an atom other than fluorine and carbon (hereinafter sometimes referred to as “etching gas components”); preferably contain a compound represented by General Formula (1) having a triple bond:

CₐF_{b}X_{c} (1)

wherein a, b, c, and X are as defined above; more preferably contain a compound represented by General Formula (2):

CₘF₂ₘ₊₁C═CY (2)

wherein m and Y are as defined above; still more preferably contain a compound represented by General Formula (3):

CF₃C═CY (3)

wherein Y is as defined above; and most preferably contain CF₃C═CCF₃, CF₃C═CF, and CF₃C═CCF₂CF₃.

An example of the most preferred dry etching gas is described as follows:

The plasma of CF₃C═CCF₃ contains a large amount of CF₃⁺ and low-molecular-weight radicals generated from CF₃C and C═C fragments. CF₃⁺, which has a high etching efficiency, enables etching at a low bias power, thus reducing damage to etching masks, such as resists, and underlying layers, such as silicon. The radicals generated from CF₃C fragments form high-density, even fluorocarbon polymer films, and the radicals generated from C═C fragments form rigid fluorocarbon polymer films with high carbon content. The fluorocarbon polymer films formed from these radicals become films that have both high rigidity, which results from the high carbon component, and high density. These films are deposited, from within the plasma, onto the substrate to be etched, and, due to a synergistic effect with the CF₃⁺-rich ions irradiated onto the substrate, form a reaction layer together with the materials to be etched (e.g., silicon oxide film and the like), and improve the etching efficiency, as well as protect etching masks, such as resists, and underlying layers, such as silicon, and improve etching selectivity. By balancing the CF₃⁺-rich ions with the low-molecular-weight radicals that are generated from the CF₃C fragments and C═C fragments, which are both precursors of the fluorocarbon films that form the above-described etching reaction layer and protective layer, the dry etching gas of the present invention selectively etches silicon materials such as silicon oxide films and/or silicon-containing, low-dielectric-constant films. When etching is conducted employing the synergistic effect of etching-efficient CF₃⁺ with the low-molecular-weight radicals that are generated from the CF₃C fragments and C═C fragments, neither an insufficient ion etching capacity, nor an excessive deposition of fluorocarbons due to high-molecular-weight radicals, nor a phenomenon of a decreased etching rate (microloading effect) is likely to occur even when etching high-aspect-ratio patterns of small contact holes, via holes, wiring traces and the like.

It is advantageous to use low-molecular-weight compounds such as CF₃C═CCF₃ and the like alone, or to use these low-molecular-weight compounds as a combined gas component such as CF₃CF═CFCF₂, CF₂═CF₂, CF₃CF═CF₂ and the like, because more CF₃⁺ is then generated and fewer high-molecular-weight radicals are generated, so the microloading effect is further decreased.

The plasma of more preferred dry etching gases, e.g., CF₃CF₂C═CCF₂CF₃, contains a large amount of both CF₃⁺ and the low-molecular-weight radicals that are generated from the CF₃CF₂ and C═C fragments.

The plasma of preferred dry etching gases, e.g., CF₃CHFC═CCHFCF₃, also attains a similar effect, and, due to the presence of hydrogen in the molecule, it further provides the effect of increased etching selectivity to silicon materials over etching masks, such as resists and the like, and underlying layers, such as silicon and the like. Moreover, the presence of hydrogen decreases the molecular weight, lowering the boiling point thereof. Thereby, compounds that previously had to be supplied by heating the gas line can be supplied easily without being heated.

Those compounds that contain a halogen such as iodine or the like instead of hydrogen have an effect of increasing the electron density by lowering the electron temperature due to a lower dissociation energy than that of fluorine. As the electron density increases, the ion density also increases, and, thereby, the etching rate increases. When the electron temperature is kept low, excessive dissociation can be suppressed, and the CF₂ radicals and CF₃⁺ that are necessary for etching become readily obtainable.

Dry etching gases usable in the present invention contain at least one compound that has the basic skeleton formed by fluorine and carbon, has a triple bond (—C═C—) structure, and may contain a heteroatom other than fluorine and carbon (hereinafter sometimes referred to as “etching gas components”), and are preferably composed of at least one compound represented by General Formula (1) having a triple bond:

CₐF_{b}X_{c} (1)

wherein a, b, c, and X are as defined above.

In the compounds represented by the General Formula (1),

a represents an integer of 2 to 7, preferably 2 to 5;

b represents an integer of 1 to 12, preferably 3 to 8; and

c represents an integer of 0 to 8, preferably 0 to 5.

More preferable etching gases are composed of at least one compound represented by General Formula (2):

CₘF₂ₘ₊₁C═CY (2)

wherein m and Y are as defined above.

The specific examples thereof are FC═CF, FC═CCF₂CF₃, IC═CF₂CF₃, FC═CCF₂CF₂CF₃, FC═CCF(CF₃)CF₃, FC═CC(CF₃)₃, CF₃CF₂C═CCF₂CF₃, FC═CCF₂CF₂CF₂CF₃, CF═CCF(CF₃)CF₂CF₃, FC═CCFCF₂(CF₃)CF₃, CF₃CF₂C═CCF₂CF₃, HC═CCF₂CF₃, HC═CCF₂CF₂CF₃, HC═CCF(CF₃)CF₃, HC═CC(CF₃)₃, CF₃CF₂C═CCHFCF₃, FC═CCHFCF₂CF₂CF₃, FC═CCH(CF₃)CF₂CF₃, and FC═CCHCF₂(CF₃)CF₃, wherein

m represents an integer of 1 to 5, preferably 1 to 3;

d represents an integer of 1 to 4, preferably 1 and 2;

e represents an integer of 0 to 9, preferably 3 to 7; and

f represents an integer of 0 to 9, preferably 0 to 6.

The dry etching gases of the invention are more preferably composed of at least one compound represented by General Formula (3):

CF₃C═CY (3)

wherein Y is as defined above.

Preferable examples of the compounds represented by General Formula (3) are CF₃C═CCF₃, CF₃C═CF, CF₃C═CCF₂CF₃, CF₃C═CCF₂CF₂CF₃, CF₃C═CCF(CF₃)CF₃, CF₃C═CC(CF₃)₃, CF₃C═CC₄F₉, CF₃C═CH, CF₃C═CI, CF₃C═CCHF₂, CF₃C═CCH₂F, CF₃C═CCH₃, CF₃C═CCHFCF₃, CF₃C═CCH₂CF₃, CF₃C═CCHFCF₂CF₃, CF₃C═CCH₂CF₂CF₃, CF₃C═CCF₂CHFCF₃, CF₃C═CCF₂CH₂CF₃, CF₃C═CCHFCHFCF₃, CF₃C═CCHFCH₂CF₃, CF₃C═CCH₂CHFCF₃, CF₃C═CCH₂CH₂CF₃, CF₃C═CCFCH₂CH₂CF₃, CF₃C═CCHCH₂CH₂CCF₃, CF₃C═CCHCHFCH₂CF₃, CF₃C═CCFCH₂CHFCF₃, CF₃C═CCH(CF₃)CF₃ and the like.

In the compounds represented by General Formula (1),

d represents an integer of 1 to 4, preferably 1 and 2;

e represents an integer of 0 to 9, preferably 3 to 7; and

f represents an integer of 0 to 9, preferably 0 to 6.

Especially preferable examples of the compounds represented by General Formula (3) are, particularly, CF₃C═CCF₃, CF₃C═CF, and CF₃C═CCF₂CF₃.

In addition to a compound that has the basic skeleton formed by fluorine and carbon, has a triple bond (—C═C—) structure, and may contain an atom other than fluorine and carbon, the dry etching gas of the invention can contain at least one member selected from the group consisting of noble gases, inert gases, NH₃, H₂, hydrocarbons, O₂, oxygen-containing compounds, halogenated compounds, HFC (hydrofluorocarbons), and PFC (perfluorocarbon) gases having a double bond (hereinafter sometimes referred to as “combined gas components”).

Preferable combined gas components include those represented by General Formula (4) having a double bond:

C_{g}FₕXᵢ (4)

wherein X is Cl, Br, I or H; g is 2 to 6; h is 4 to 12; i is 0 to 2; and h+i is 2g.

More preferable combined gas components are those compounds represented by General Formula (5):

Rfh=CX¹Y¹ (5)

wherein Rfh is one member selected from the group consisting of CF₃CF, CF₃H, and CF₂; and X¹ and Y¹ are the same or different, and independently represent F, Cl, Br, I, H or CⱼFₖHₗ (j is 1 to 4, and k+l is 2j+1). Especially preferable is at least one member selected from the group consisting of CF₃CF═CFCF₃, CF₂═CF₂, and CF₃CF═CF₂.

Specifically, the dry etching gas of the invention may contain, together with the etching gas component, at least one combined gas component selected from the group consisting of noble gases such as He, Ne, Ar, Xe and Kr; inert gases such as N₂ and the like; NH₃; H₂; hydrocarbons such as, CH₄, C₂H₆, C₃H₈, C₂H₄, C₃H₆ and the like; O₂; oxygen-containing compounds such as CO, CO₂, (CF₃)₂C═O, CF₃CFOCF₂, CF₃OCF₃ and the like; halogenated compounds such as CF₃I, CF₃CF₂I, (CF₃)₂CFI, CF₃CF₂CF₂I, CF₃Br, CF₃CF₂Br, (CF₃)₂CFBr, CF₃CF₂CF₂Br, CF₃Cl, CF₃CF₂Cl, (CF₃)₂CFCl, CF₃CF₂CF₂Cl, CF₂═CFI, CF₂═CFCl, CF₂═CFBr, CF₂=Cl₂, CF₂═CCl₂, CF₂═CBr₂ and the like; HFC (hydrofluorocarbon) gases such as CH₂F₂, CHF₃, CF₃CHF₂, CHF₂CHF₂, CF₃CH₂F, CHF₂CH₂F, CF₃CH₃, CH₂FCH₂F, CH₃CHF₂, CH₃CH₂F, CF₃CF₂CF₂H, CF₃CHFCF₃, CHF₂CF₂CHF₂, CF₃CF₂CH₂F, CF₂CHFCHF₂, CF₃CH₂CF₃, CHF₂CF₂CH₂F, CF₃CF₂CH₃, CF₃CH₂CHF₂, CH₃CF₂CHF₂, CH₃CHFCH₃, CF₂═CHF, CHF═CHF, CH₂═CF₂, CH₂═CHF, CF₃CH═CF₂, CF₃CH═CH₂, CH₃CF═CH₂, and the like; and PFC (perfluorocarbon) gases having at least one single bond or double bond such as CF₄, C₂F₆, C₃F₈, C₄F₁₀, c-C₄F₈, CF₂═CF₂, CF₂═CFCF═CF₂, CF₃CF═CFCF═CF₂, c-C₅F₈, and the like.

When a compound having CF₃CF directly bonded to a double bond, a compound represented by General Formula (4), a compound represented by General Formula (5), CF₃CF═CFCF₃, or CF₃CF═CF₂ is used as a combined gas component, the etching effect is further increased due to the synergistic effect. Also in a gas plasma of these compounds, CF₃⁺, which has a high etching efficiency, is selectively generated, and high-density, even fluorocarbon polymer films that are formed by the radicals generated from CF₃CF fragments are deposited on the substrate to be etched. An etching reaction layer and a protective layer that are derived from these polymer films are formed, and CF₃⁺-rich ions that are selectively generated from CF₃C═CCF₃ and CF₃CF═CFCF selectively etch silicon materials such as silicon oxide films and/or silicon-containing, low-dielectric-constant films over etching masks and underlying layers such as silicon and the like. The use of a low-molecular-weight compound such as CF₃CF═CFCF₃, CF₃CF═CF₂ or the like as a combined gas component provides advantages in that few high-molecular-weight radicals are generated and the microloading effect in not likely to occur.

The use of CF₂═CF₂ as a combined gas component increases the etching selectivity to silicon materials such as oxide films over etching masks, such as resist, and underlying layers, such as silicon. Although CF₃⁺ is not selectively generated in the plasma, a high-density, even fluorocarbon polymer having CF₂ radicals as a main component is deposited on the substrate to be etched. Then, an etching reaction layer and a protective layer that are derived from this polymer film are formed, and CF₃⁺-rich ions that are selectively generated from CF₃C═CCF₃ selectively etch silicon materials such as silicon oxide films and/or silicon-containing, low-dielectric-constant films. When CF₂═CF₂ is used as a combined gas component, although etching efficiency is decreased slightly, the use thereof provides increased etching selectivity since the fluorocarbon film derived from a large amount of CF₂ radicals generated from CF₂═CF₂ forms a reaction layer with high etching efficiency and a protective layer with high density. High-molecular-weight radicals are not generated, and, therefore, the microloading effect is substantially low.

A noble gas such as He, Ne, Ar, Xe, Kr or the like can change the electron temperature and the electron density of the plasma and also has a diluting effect. Through the simultaneous use of such a noble gas, a suitable etching condition can be selected by controlling the balance among fluorocarbon radicals and fluorocarbon ions.

With N₂, H₂ or NH₃ in the combination, an excellent etching shape is obtained in the etching of low-dielectric-constant films. It is reported in, for example, S. Uno et al. Proc. Symp. Dry. Process. Tokyo (1999): 215-220 that when etching a low-dielectric-constant film made of an organic SOG film using a mixed gas of c-C₄F₈ and Ar that is further mixed with N₂, a better etching shape is obtained than when using a mixed gas of c-C₄F₈ and Ar that is further mixed with O₂.

Hydrocarbons and HFC improve etching selectivity by depositing, within the plasma, a polymer film that has high carbon content onto etching masks, such as resist and the like, and underlying layers, such as silicon. Further, HFC itself has the effect of generating ions such as CHF₂ and the like that are used as etching species.

Hydrogen contained in H₂, NH₃, hydrocarbons, HFC, etc., bonds with fluorine radicals and becomes hydrogen fluoride, and provides the effect of removing fluorine radicals from the plasma system, and, thereby, the reaction between fluorine radicals and etching masks, such as resist and the like, or underlying layers, such as silicon, is reduced and the etching selectivity is improved.

The term “oxygen-containing compounds” refers to those compounds containing oxygen, for example, CO; CO₂; ketones such as acetone, (CF₃)₂C═O and the like; epoxides such as CF₃CFOCF₂ and the like; and ethers such as CF₃OCF₃ and the like. The use of these oxygen-containing compounds or O₂ in combination removes excessive fluorocarbon polymer films, suppresses the decrease of the etching rate in the etching of fine patterns (microloading effect), and provides the effect of preventing etch-stopping.

The term “halogenated compounds” herein refers to those compounds wherein fluorine contained in the fluorocarbon molecule is substituted with bromine, iodine or the like, such as CF₃I, CF₃CF₂I, (CF₃)₂CFI, CF₃CF₂CF₂I, CF₃Br, CF₃CF₂Br, (CF₃)₂CFBr, CF₃CF₂CF₂Br, CF₃Cl, CF₃CF₂Cl, (CF₃)₂CFCl, CF₃CF₂CF₂Cl, CF₂═CFI, CF₂═CFCl, CF₂═CFBr, CF₂=Cl₂, CF₂═CCl₂, CF₂═CBr₂ and the like. By substituting the fluorine contained in the fluorocarbon molecule with chlorine, bromine, iodine or the like, the bond is weakened. Thereby, a plasma having a high electron density and a low electron temperature can be readily generated.

The higher the electron density, the higher the ion density, and consequently the faster the etching rate. When the electron temperature is kept low, excessive dissociation can be suppressed, and the CF₂ radicals and CF₃⁺ necessary for etching become readily obtainable. Iodine-containing compounds are highest in the ability to provide such an effect. As disclosed in Japanese Unexamined Patent Application No. 340211/1999, Jpn. J. Appl. Rhys. Vol. 39 (2000) pp. 1,583-1,596, etc., the electron density of iodine-containing compounds is readily increased even when the electron temperature thereof is low, and some of the iodine-containing compounds selectively produce CF₃⁺.

HFC and PFC that have a double bond within their molecule have little effect on global warming, and because such a double bond is likely to dissociate in plasma, it is easy to control the generation of radicals and ions necessary for etching.

When a mixed gas containing a combined gas component and an etching gas component that has CF₃C directly bonded to a triple bond is used as the dry etching gas of the invention, usually, at least one combined gas component is used in a flow rate of about 90% or less, and at least one etching gas component is used in a flow rate of about 10% or more. Preferably, at least one combined gas component is used in a flow rate of about 1 to about 80%, and at least one etching gas component is used in a flow rate of about 20 to about 99%. Preferable combined gas components include at least one species selected from the group consisting of Ar, N₂, O₂, CO, CF₃CF═CFCF, CF₂═CF₂, CF₃CF═CF₂, CF₃I and CH₂F₂.

Silicon materials such as silicon oxide films and/or silicon-containing, low-dielectric-constant films include organic SOG films such as organic, high-molecular-weight materials having a siloxane bond like MSQ (methylsilsesquioxanes) and the like, inorganic insulation films such as HSQ (hydogensilsesquioxanes) and the like, porous films thereof, films containing F (fluorine) in a silicon oxide film such as SiOF and the like, silicon nitride films, SiOC films, and the like. Although these silicon materials are usually formed into film by means of coating, CVD (chemical vapor deposition) and the like, the method is not limited to these cited herein.

Silicon materials such as silicon oxide films and/or silicon-containing, low-dielectric-constant films are not limited to those having a film or layer structure, and include those in which an entire material having a silicon-containing chemical formula is composed of the material itself. A solid material such as glass, quartz plate or the like can be cited as an example.

Silicon materials such as silicon oxide films and/or silicon-containing, low-dielectric-constant films can be selectively etched over etching masks such as resist, polysilicon and the like, and underlying layers such as silicon, silicon nitride film, silicon carbide, silicide, metal nitride and the like. Further, in the production process of semiconductors, it may be necessary to sequentially etch materials, such as silicon-material layers, and underlying layers, such as silicon nitride films and other etch-stopper films. In a case such as that described above, it is possible to sequentially etch silicon-material layers and underlying layers such as etch-stopper films by selecting a condition where the etching of the etching masks such as resists proceeds more slowly than the etching of the underlying layers,

The preferred etching conditions are as follows.

Discharge power: 200 to 3,000 W, and preferably 400 to 2,000 W.

Bias power: 25 to 2,000 W, and preferably 100 to 1,000 W.

Pressure: 100 mTorr (3.99 Pa) or less, and preferably 2 to 50 mTorr.

Electron density: 10⁹ to 10¹³ cm⁻³, and preferably 10¹⁰ to 10¹² cm⁻³.

Electron temperature: 2 to 9 eV, and preferably 2 to 7 eV.

Wafer temperature: −40 to 100° C., and preferably −30 to 50° C.

Chamber wall temperature: −30 to 300° C., and preferably 20 to 200° C.

The discharge power and bias power vary according to the chamber and electrode sizes. When patterns such as a contact hole and the like are etched into a silicon oxide film and/or a silicon nitride film and/or a silicon-containing, low-dielectric-constant film in an inductively coupled plasma (ICP) etching reactor (chamber volume: 3,500 cm³) designed for small-diameter wafers, the preferable conditions are:

Discharge power: 200 to 1,000 W, and preferably 300 to 600 W; and

Bias power: 50 to 500 W, and preferably 100 to 300 W.

These values increase as the wafer diameter increases.

### BEST MODE FOR CARRYING OUT THE INVENTION

Examples and Comparative Examples are given below to illustrate the invention in more detail.

### EXAMPLE 1 AND COMPARATIVE EXAMPLE 1

The etching quality of cyclic C₄F₈ (Comparative Example 1) and CF₃C═CCF₃ (Example 1) was compared under the etching conditions of 1,000 W of ICP (inductively coupled plasma) discharge power, 250 W of bias power, 5 mTorr of pressure, 9×10¹⁰ to 1.5×10¹¹ cm⁻³ of electron density, and 3.8 to 4.1 eV of electron temperature. Table 1 shows the etching rate, selectivity and hole diameter (in μm) at the bottom of a 0.2-μm-diameter hole when a semiconductor substrate having a silicon dioxide (SiO₂) film with a thickness of about 1 μm on an Si substrate, and a resist pattern with a 0.2-μm-diameter hole formed thereon, was etched to the depth of about 1 μm. While the etching rate of CF₃C═CCF₃ is lower than that of the conventional cyclic c-C₄F₈ etching gas, the etching selectivity thereof over the resist is higher. With regard to c-C₄F₈, the diameter at the bottom of the hole is 0.10 μm, which is smaller than the diameter at the top of the hole, indicating a tendency for the etching to stop. On the other hand, using CF₃C═CCF₃, the etching proceeds to the bottom of the hole as is intended for the resist pattern.

TABLE 1

| | | | Diameter (μm) at |
|---|---|---|---|
| | Etching rate | | the bottom of the |
| Etching | of SiO₂ film | | 0.2-μm-diameter |
| gas | (nm/min) | Selectivity | hole |
| c-C₄F₈ | 610 | 2.0 | 0.10 |
| CF₃C═CCF₃ | 580 | 2.5 | 0.20 |

### EXAMPLE 2 AND COMPARATIVE EXAMPLE 2

Contact holes were etched under the conditions of 1,000 W of ICP (Inductively Coupled Plasma) discharge power, 250 W of bias power and 5 mTorr of pressure, using a mixed gas of CF₃C═CCF₃ and CF₃CF═CFCF₃ (flow rate: 35%/65%; Example 2), and a known etching gas, i.e., a mixed gas of c-C₄F₈ and Ar (flow rate: 35%/65%; Comparative Example 2). Table 2 shows a comparison of the etching rates of the two gases and the reduction in their etching rates for a 0.2-μm-diameter contact hole against a plane surface.

The reduction in the etching rate of the mixed gas of CF₃C═CCF₃ and CF₃CF═CFCF₃ is lower than that of the mixed gas of c-C₄F₈ and Ar. Therefore, the etching gas of the present invention can be suitably used to etch patterns having different sizes at substantially the same etching rate, and to achieve shorter etching times of the underlying layers to produce semiconductor devices with little damage.

TABLE 2

| | Flow | Etching rate of | Reduction |
|---|---|---|---|
| | rate | SiO₂ film | in etching |
| Etching gas | (%) | (nm/min) | rate (%) |
| CF₃C═CCF₃/CF₃CF═CFCF₃ | 35/65 | 570 | 25 |
| c-C₄F₈/Ar | 35/65 | 580 | 35 |

By achieving a balance between ions that are rich in selectively-generated CF₃⁺, which has a high etching efficiency, and etching reaction layers and protective layers with high-density, even fluorocarbon films having a high carbon content and rigidity formed by radicals generated from the CF₃C and C═C fragments, the gas plasma of the dry etching gas of the present invention lessens the microloading effect and selectively etches silicon materials such as silicon oxide films and/or silicon-containing, low-dielectric-constant films.

CF₃⁺ improves etching efficiency and is, thereby, capable of etching at a low bias power, resulting in reduced damage to resists and underlying layers such as silicon, etc. The radicals generated from CF₃C fragments form high-density, even fluorocarbon polymer films, and the radicals generated from C═C fragments form rigid fluorocarbon polymer films with high carbon component. The etching reaction layers and protective layers derived from films having such properties increase the etching efficiency of the materials to be etched and protect etching masks, such as resists and the like, and underlying layers, such as silicon and the like, and improve etching selectivity. By controlling the balance between CF₃⁺, which has a high etching efficiency, and the radicals that are derived from the CF₃C and C═C fragments and that form high-density, even fluorocarbon films with high carbon content and rigidity, the present invention achieves etching that exhibits little microloading effect and that is free of etch-stopping.

1. A dry etching gas comprising a compound that has a fluorocarbon skeleton and a triple bond and may contain a heteroatom.

2. The dry etching gas according to claim 1 comprising at least one triple-bond-containing compound represented by General Formula (1):
General formula (1):
CₐF_{b}X_{c} (1)
wherein X is Cl, Br, I or H; a is 2 to 7; b is 1 to 12; c is 0 to 8; and b+c is 2a −2.

3. The dry etching gas according to claim 1 comprising at least one compound represented by General Formula (2):
C_{mF}₂ₘ₊₁C═CY (2)
wherein m is 1 to 5, Y is F, I, H or C_{d}FₑH_{f} (d is 1 to 4, e is 0 to 9, f is 0 to 9, e+f is 2d+1, and m+d is smaller than 6).

4. The dry etching gas according to claim 1 comprising at least one compound represented by General Formula (3):
CF₃C═CY (3)
wherein Y is F, I, H or C_{d}FₑH_{f} (d is 1 to 4, e is 0 to 9, f is 0 to 9, e+f is 2d+1).

5. The dry etching gas according to claim 4 comprising at least one member selected from the group consisting of CF₃C═CCF₃, CF₃C═CF, and CF₃C═CCF₂CF₃.

6. The dry etching gas according to claim 5 comprising CF₃C═CCF₃.

7. The dry etching gas according to any of claims 1 to 5 further comprising at least one member selected from the group consisting of CF₃CF═CFCF₃, CF₂═CF₂, and CF₃CF═CF₂.

8. The dry etching gas according to claim 6 further comprising CF₃CF═CFCF₃.

9. The dry etching gas according to any of claims 1 to 6 further comprising at least one double-bond-containing compound represented by General Formula (4):
C_{g}FₕXᵢ (4)
wherein X is Cl, Br, I or H; g is 2 to 6; h is 4 to 12; i is 0 to 2; and h+i is 2g.

10. The dry etching gas according to any of claims 1 to 6 further comprising at least one compound represented by General Formula (5):
Rfh=CX¹Y¹ (5)
wherein Rfh is one member selected from the group consisting of CF₃CF, CF₃CH, and CF₂; and X¹ and Y¹ are the same or different, and independently represent F, Cl, Br, I, H or CⱼFₖHₗ (j is 1 to 4, and k+l is 2j+1).

11. The dry etching gas according to any of claims 1 to 6 further comprising at least one compound represented by General Formula (6):
Rf=C(CₚF₂ₚ₊₁)(C_{q}F_{2q+1}) (6)
wherein Rf is CF₃CF or CF₂; p and q are the same or different, and independently represent 0, 1, 2 or 3; and p+q is smaller than 5.

12. The dry etching gas according to any of claims 1 to 8 further comprising at least one member selected from the group consisting of noble gases, inert gases, NH₃, H₂, hydrocarbons, O₂, oxygen-containing compounds, halogenated compounds, HFC (hydrofluorocarbons), and PFC (perfluorocarbon) gases having at least one single bond or double bond.

13. The dry etching gas according to any of claims 1 to 8 further comprising at least one member of gas selected from the group consisting of noble gases such as He, Ne, Ar, Xe and Kr; inert gases such as N₂; NH₃; H₂; hydrocarbons such as CH₄, C₂H₆, C₃H₈, C₂H₄, C₃H₆ and the like; O₂; oxygen-containing compounds such as CO, CO₂, (CF₃)₂C═O, CF₃CFOCF₂, CF₃OCF₃ and the like; halogenated compounds such as CF₃I, CF₃CF₂I, (CF₃)₂CFI, CF₃CF₂CF₂I, CF₃Br, CF₃CF₂Br, (CF₃)₂CFBr, CF₃CF₂CF₂Br, CF₃Cl, CF₃CF₂Cl, (CF₃)₂CFCl, CF₃CF₂CF₂Cl, CF₂═CFI, CF₂═CFCl, CF₂═CFBr, CF₂=Cl₂, CF₂═CCl₂, CF₂═CBr₂ and the like; HFC (hydrofluorocarbons) such as CH₂F₂, CHF₃, CF₃CHF₂, CHF₂CHF₂, CF₃CH₂F, CHF₂CH₂F, CF₃CH₃, CH₂FCH₂F, CF₂═CHF, CHF═CHF, CH₂═CF₂, CH₂═CHF, CF₃CH═CF₂, CF₃CH═CH₂, CH₃CF═CH₂, and the like; and PFC (perfluorocarbon) gases having at least one single bond or double bond such as CF₄, C₂F₆, C₃F₈, C₄F₁₀, c-C₄F₈, CF₂═CF₂, CF₂═CFCF═CF₂, CF₃CF═CFCF═CF₂, c-C₅F₈, and the like.

14. A dry etching method comprising etching a silicon material such as a silicon oxide film and/or a silicon-containing, low-dielectric-constant film by means of a gas plasma of the dry etching gas defined in any of claims 1 to 13.
